(19) United States
(12) Patent Application Publication
(10) Pub. No.: US 2014/0272403 A1
(43) Pub. Date: Sep. 18, 2014

(54) FORMALDEHYDE-FREE PLYWOOD AND PREPARATION THEREOF

(71) Applicant: RESEARCH INSTITUTE OF WOOD INDUSTRY, CHINESE ACADEMY OF FORESTRY, Haidan District (CN)

(72) Inventors: Liang CHANG, Beijing (CN); Zheng Wang, Beijing (CN); Wenjing Guo, Beijing (CN); Li Gao, Beijing (CN); Yiping Ren, Beijing (CN)

(73) Assignee: RESEARCH INSTITUTE OF WOOD INDUSTRY, CHINESE ACADEMY OF FORESTRY, Haidan District (CN)

(21) Appl. No.: 14/015,159

(22) Filed: Aug. 30, 2013

(30) Foreign Application Priority Data
Mar. 13, 2013 (CN) 201310080167.9

(51) Int. Cl. B27D 1/04; B32B 37/06; B32B 37/18

(52) U.S. Cl. CPC B27D 1/04; B32B 37/182; B32B 37/06
USPC 428/339; 428/513; 156/306.6

(57) ABSTRACT

The present invention discloses a method for preparation of formaldehyde-free plywood from scrap plastic alloys. Different scrap plastics are used to prepare plastic alloy film, which is then used as an adhesive material for the preparation of new plywood without formaldehyde emission. The formaldehyde-free plywood according to the present invention is prepared by the following steps: different scrap plastics are crushed, cleaned separately, and then corresponding fillers and additives are added to the above crushed material or their mixtures which mixed according to a certain blending ratio; plastic alloy film of certain size and thickness is prepared after the film blowing and rolling processes; after being assembled with wood veneers to form a lay-up mat, the mat is hot pressed and then cold pressed. The present invention provides a method of preparing non-toxic and environmentally friendly formaldehyde-free plywood, solving the problem that the environment and human beings being poisoned by the free formaldehyde released from ordinary plywood and at the same time providing a way of recycling and reusing scrap plastics.

### TECHNICAL FIELD

The present invention relates to a formaldehyde-free plywood prepared by scrap plastic alloys and a method of preparing the same, especially to a method of preparing the formaldehyde-free plywood by scrap plastic alloy film.

### TECHNICAL BACKGROUND

Currently, the adhesives used in plywood and decorative plywood products in the market are mostly formaldehyde adhesives. In producing and using the products, large amounts of free formaldehyde are released, causing indoor air pollutions, which are great threats to the health of both producers and consumers.

CN 200710100722.4 entitled as “Method of producing high density polyethylene plywood” discloses a method of preparing plywood with high density polyethylene instead of adhesives such as urea formaldehydes, phenolic aldehydes, etc. and by respectively rolling pinholes on veneers, making a lay-up and heating and pressing the mat. High density polyethylene (HDPE) is non-toxic, tasteless and has good acid and alkali resistance. However, HDPE has poor anti-aging performance, poor environment cracking resistance, and is easily subjected to stress cracking, aging, deformation, especially to performance decrease under thermal oxidation. When HDPE alone is used to produce plywood, the product obtained cannot reach Type I weather resistant plywood standard with respect to water resistance. Moreover, processing a veneer by rolling pinholes thereon would easily lead to veneer stress concentration, which generates a great deal of grain cracking, thus greatly reducing the veneers' tensile strength parallel to the grains.

On the other hand, a large number of scrap plastics lead to “white pollution”, which has become a major problem in the development of society. Recycling the scrap plastics is an important way to solve the above problem.

When recycled scrap plastics are used in the preparation of plastic alloys, the performances of different plastics are complemented with one another. Meanwhile, a variety of additives can be added to the plastic alloys to produce plywood. In this way, not only the problem of formaldehyde in plywood products is solved, but also the “white pollution” brought about by scrap plastics is eliminated. More importantly, plywood prepared by scrap plastic alloys has excellent physical performances and can be used to prepare Type I plywood (weather resistant type) and Type II plywood (water resistant type) in accordance with different formulas, which are widely used in the fields of structural plywood, concrete plywood formwork, decorative plywood, furniture plywood, parquet, etc.

### SUMMARY OF THE INVENTION

The present invention aims to provide a method of preparing formaldehyde-free plywood with scrap plastic alloys. This method is safe, non-toxic and environmentally friendly, solving the problem of the environment and human beings being poisoned by free formaldehyde released from ordinary plywood while recycling scrap plastics and relieving the “while pollution” problem.

To this end, the following technical means are adopted by the present invention:

A formaldehyde-free plywood comprising at least two veneers is adopted, wherein the two wood veneers are bonded through scrap plastic alloy film free of formaldehyde.

Preferably, the wood veneers are sheets formed by rotary cutting or slicing softwood or hardwood timber, wherein the thickness of the sheets falls within a range from 0.1 to 10 mm, further preferably from 1 to 3 mm.

Preferably, the timber for the wood veneers is selected from poplar, birch, eucalyptus, fir or pine.

Preferably, the plastic scrap alloy film comprises:

(a) scrap plastics;

(b) based on (a), 0.001 to 15 wt % of a lubricant;

(c) based on (a), 0.001 to 12 wt % of a compatilizer; and

(d) based on (a), 0.001 to 25 wt % of a filler.

The scrap plastics according to the present invention are preferably thermoplastics. In one embodiment, the scrap plastics comprise polypropylene and two, three or four selected from the group consisting of low density polyethylene, high density polyethylene, polyvinyl chloride, polystyrene and polycarbonates.

Preferably, the lubricant is selected from the group consisting of ethylene bis stearamide, zinc stearate, aliphatic hydrocarbon waxes, oxidized polyethylene and polyvinylidene or any combinations thereof; the compatilizer is selected from the group consisting of stearic acid, titanate coupling agents, silane coupling agents or any combinations thereof; and the filler is selected from the group consisting of talcum powder, light calcium carbonate and diatomite or any combinations thereof.

The present invention also aims to provide a method of preparing the formaldehyde-free plywood, comprising the flowing steps:

Step (i): preparing the scrap plastic alloy film;

Step (ii): preparing a plywood mat; and

Step (iii): preparing the formaldehyde-free plywood,

wherein, Step (i) further comprises: classifying various types of scrap plastics and crushing the same respectively through plastic crushing machines and then cleaning them; blending the crushed particles with lubricant, compatilizer and filler according to a certain ratio; and mixing, prilling, film blowing or rolling the mixture to produce the scrap plastic alloy film, which has a thickness in a range from 0.01 to 3 mm.

In some specific embodiments of the present invention, the temperatures in the processes of mixing, prilling, film blowing and rolling are all higher than the highest melting temperature of the scrap plastics, preferably in a range from 120 to 250° C.

In some other specific embodiments of the present invention, Step (ii) further comprises: after drying at least two wood veneers, laying the scrap plastic alloy film therebetween, the grains in two adjacent veneers being vertically crossed with each other or the plywood as a whole being centrally symmetrical.

In some further specific embodiments of the present invention, Step (iii) further comprises: firstly hot pressing and then cold pressing the plywood mat. The hot pressing temperature is 10 to 50° C., higher than the highest melting temperature of the scrap plastics, preferably 120 to 260° C., the hot pressing pressure is 0.8 to 10 Mpa, and the hot pressing time based on the plywood thickness is 0.4 to 3 min/mm. The cold pressing temperature is lower than the lowest melting temperature of the plastic alloy materials, the cold pressing pressure is no less than the hot pressing pressure, and the core temperature after the cold pressing is at least 30° C., lower than the lowest melting temperature of the plastic alloy materials.

Compared with ordinary plywood in the prior art, the present invention excels at least in the following aspects:

1. The plywood prepared from scrap plastic alloy film releases no formaldehyde, completely solving the problem of the environment and human beings being harmed by formaldehyde, which has been troubling plywood production and use over the years.

2. When scrap plastic alloy film is used as the glue, the performances of various plastics in the alloy are complemented to one another, ensuring excellent physical performances and water resistance of the plywood.

3. No special treatment such as rolling pinholes is needed in the present application. Instead, based on the complementary performances of various plastics, hot pressing is first performed to melt the plastics, which would extend on the surface and permeate into the timber. After that, cold pressing is performed to cool and solidify the melted plastics inside the timber to form glue nails, which can bond and fasten the wood veneers.

4. The plywood bonding materials mainly adopt recycled scrap plastics, which are not only of low price but also can solve the problem of environment pollution caused thereby.

5. The plywood of the present invention can be widely used in the fields of structural plywood, concrete plywood formwork, decorative plywood, furniture plywood, parquet, etc.

### EMBODIMENTS

The percentages (%) used in this application, unless otherwise indicated, represent mass percentages.

The scrap plastics of the present invention include but are not limited to low density polyethylene, high density polyethylene, polypropylene, polyvinyl chloride, polystyrene, polycarbonates, etc. In one specific embodiment, the scrap plastics of the present invention refer to plastics whose melting temperatures are in a range from 80 to 200° C., and whose synthetic materials are free of formaldehyde. When scrap plastics are used to prepare a plastic alloy, not more than four kinds of plastics are generally used as raw materials, and the combinations of 2 or 3 or 4 different sources of scrap plastics are preferred.

The lubricant of the present invention is selected from but not limited to the group consisting of ethylene bis stearamide, zinc stearate, aliphatic hydrocarbon waxes, oxidized polyethylene and polyvinylidene; the compatilizer is selected from but not limited to the group consisting of stearic acid, titanate coupling agents and silane coupling agents; and the filler is selected from but not limited to the group consisting of talcum powder, light calcium carbonate and diatomite.

In one specific embodiment, the formaldehyde-free plywood of the present invention comprises three layers of wood veneers and the wood veneers are bonded through scrap plastic alloy film made of a variety of formaldehyde-free scrap plastics.

In some specific embodiments, the scrap plastic alloy film comprises,

(a) scrap plastics;

(b) based on (a), 1 to 10 wt % of a lubricant;

(c) based on (a), 1 to 10 wt % of a compatilizer; and

(d) based on (a), 1 to 20 wt % of a filler.

The preparation of formaldehyde-free plywood from scrap plastics according to the present invention comprises two aspects, i.e., the preparation of scrap plastic alloy film and the preparation of formaldehyde-free plywood.

The scrap plastic alloy film is prepared through the following steps: various types of scrap plastics are respectively classified, crushed through plastic crushing machines and then cleaned, and after the scrap plastics, the lubricant, the compatilizer and the filler are selected according to a certain ratio, they are mixed, prilled, film blown or rolled to produce scrap plastic film of certain size and thickness, which is selected as within a range from 0.01 to 3 mm, preferably 0.1 to 2 mm and more preferably 0.5 to 1 mm.

The temperatures in the processes of mixing, prilling, film blowing or rolling are different based on the different melting temperatures of the plastics. The temperatures in the processes should be higher than the highest melting temperature of the scrap plastics, preferably in a range from 120 to 250° C. Other parameters therein are determined by the processing machinery.

The formaldehyde-free plywood is prepared by firstly hot pressing the plywood mat and then cold pressing the same.

The plywood mat is composed of more than three layers of dried wood veneers, with scrap plastic alloy film laid between every two adjacent veneers. The grains in two adjacent veneers are vertically crossed with each other or the plywood as a whole is centrally symmetrical.

In some specific embodiments, the wood veneers can be sheets formed by rotary cutting or slicing various softwood and hardwood timbers including poplar, birch, eucalyptus, fir, pine, etc.

In another specific embodiment, the conditions for the hot pressing are that the hot pressing temperature is generally 10 to 50° C., higher than the highest melting temperature of the plastic alloy materials, the hot pressing temperature being 120 to 260° C., the surface pressure being 0.8 to 10 Mpa, and the hot pressing time based on the plywood thickness being 0.4 to 3 min/mm.

In yet another specific embodiment, the conditions for the cold pressing are that the cold pressing temperature is lower than the lowest melting temperature of the plastic alloy materials, the cold pressing pressure being not lower than the hot pressing pressure, and the core temperature is most properly room temperature and at least 30° C., lower than the lowest melting temperature of the plastic alloy materials.

### EXAMPLES

In the following, some preferable examples will be used to further elaborate the technical means of the present invention in order to achieve the intended targets.

Examples 1 to 3 respectively illustrate the specific examples using three different scrap plastics for the preparation of formaldehyde-free plywood. Examples 4 to 6 illustrate the specific examples using the combinations of three scrap plastics for the preparation of formaldehyde-free plywood. The following examples are all provided to further illustrate rather than to limit the present invention in any way. Any technical means obvious for one ordinarily skilled in the art and any equivalent variations of the materials and methods disclosed by the present invention shall fall within the protection scope of the present application.

### Example 1

Film blowing devices are adopted by the present invention to prepare high density polyethylene (HDPE) scrap plastic film, which is used as a bonding material for the preparation of a 5-layer formaldehyde-free birch plywood (5-mm thick) by the following steps:

1. High density polyethylene (HDPE) scrap plastic is recycled;

2. The recycled high density polyethylene scrap plastic is cleaned, crushed and dried by a circulating water plastic cleaning and crushing machine;

3. The crushed high density polyethylene material, a lubricant, a compatilizer and a filler are mixed and prilled according to a certain ratio. The formed plastic alloy particles are then film blown to prepare plastic alloy film of a certain size;

4. The dried firm birch veneers (1.2-mm thick) are patched, put together and assembled with the plastic alloy film to form a 5-layer birch plywood mat. The grains in two adjacent veneers are vertically crossed with each other. Plastic alloy film of the same size with the veneers is laid between every two adjacent veneers;

5. The plywood mat is hot pressed, cold pressed successively and then set to form the plywood.

In the above steps:

The processes of cleaning, crushing and drying the high density polyethylene (HDPE) scrap plastic: HDPE is treated by a circulating water plastic cleaning and crushing machine, cleaned and crushed simultaneously therein, the impurities and grease on the surface thereof being removed, and then is processed into fragments of proper sizes, which are then dried.

On the above basis, zinc stearate which accounts for 7% by weight of the plastic as the lubricant, titanate coupling agent which accounts for 4% by weight of the plastic as the compatilizer, and diatomite which accounts for 15% by weight of the plastic as the filler are respectively added.

The film blowing process: the scrap plastic combination is mixed, prilled and film blown to produce plastic alloy film of certain width, e.g. 1.2-meter wide (matching with the size of common sheets of 1.22 m*2.44 m), whose thickness is 0.2 mm. The temperature of the film blowing process is in a range from 190 to 240° C.

Hot pressing: the hot pressing temperature is 170° C., the hot pressing pressure is 2 Mpa and the hot pressing time is 6 min.

Cold pressing: the cold pressing temperature is 20° C., the cold pressing pressure is 1.5 Mpa and the cold pressing time is 5 min.

### Example 2

Polypropylene (PP) scrap plastic film is prepared, which is used as a bonding material for the preparation of a 5-layer formaldehyde-free poplar plywood (5-mm thick). The steps are the same as those in Example 1.

Mixing the scrap plastic: polyvinylidene fluoride which accounts for 6% by weight of the plastic as the lubricant, maleic anhydride-modified polypropylene which accounts for 4% by weight of the plastic as the compatilizer and light calcium carbonate which accounts for 20% by weight of the plastic as the filler are respectively added.

The thickness of the alloy is 0.2 mm. The temperature of the film blowing process is in a range from 170 to 240° C.

Hot pressing: the hot pressing temperature is 190° C., the hot pressing pressure is 2 Mpa and the hot pressing time is 6 min.

Cold pressing: the cold pressing temperature is 20° C., the cold pressing pressure is 1.5 Mpa and the cold pressing time is 5 min.

### Example 3

Low density polyethylene (LDPE) scrap plastic film is prepared, which is used as a bonding material for the preparation of a 5-layer formaldehyde-free poplar plywood (5-mm thick). The steps are the same as those in Example 1.

Mixing the scrap plastic: polyethylene which accounts for 8% by weight of the plastic as the lubricant, stearic acid which accounts for 6% by weight of the plastic as the compatilizer and diatomite which accounts for 25% by weight of the plastic as the filler are respectively added.

The thickness of the alloy is 0.2 mm. The temperature of the film blowing process is in a range from 150 to 180° C.

Hot pressing: the hot pressing temperature is 160° C., the hot pressing pressure is 2 Mpa and the hot pressing time is 6 min.

Cold pressing: the cold pressing temperature is 20° C., the cold pressing pressure is 1.5 Mpa and the cold pressing time is 5 min.

### Example 4

Film blowing devices are adopted by the present invention to prepare low density polyethylene (LDPE) and polypropylene (PP) scrap plastic alloy film, which is used as an adhesive material for the preparation of a 5-layer formaldehyde-free birch plywood (5-mm thick) by the following steps:

1. Low density polyethylene (LDPE) and polypropylene (PP) scrap plastics are classified and recycled;

2. The recycled low density polyethylene (LDPE) and polypropylene (PP) scrap plastics are respectively cleaned, crushed and dried by a circulating water plastic cleaning and crushing machine;

3. The crushed low density polyethylene (LDPE) and polypropylene (PP) scrap plastic materials, a lubricant, a compatilizer and a filler are mixed and grilled according to a certain ratio. The formed plastic alloy particles are then film blown to prepare the plastic alloy film of a certain size;

4. Dried birch veneers (1.2-mm thick) are patched, put together and assembled with the plastic alloy film to form a 5-layer birch plywood mat. The grains in two adjacent veneers are vertically crossed with each other. Plastic alloy film of the same size with the veneers is laid between every two adjacent veneers.

5. The plywood mat is hot pressed, cold pressed successively and then set to form the plywood.

In the above steps:

The processes of cleaning, crushing and drying the scrap plastics: the plastics are treated by a circulating water plastic cleaning and crushing machine, cleaned and crushed simultaneously therein, the impurities and grease on the surface thereof being removed, and then are processed into fragments of proper sizes, which are then dried.

The process of mixing the scrap plastics: the weight percentage of low density polyethylene is 40% and that of polypropylene is 60%. On the above basis, polyethylene wax which accounts for 2% by weight of the sum content of plastics and zinc stearate which accounts for 1% by weight of sum content of plastics as the lubricants, maleic anhydride-modified polypropylene which accounts for 3% by weight of the sum content of plastics as the compatilizer and talcum powder which accounts for 5% by weight of the sum content of plastics as the filler are respectively added.

The film blowing process: the combination of the scrap plastics is mixed, prilled and film blown to produce plastic alloy film of a certain size (0.2-mm wide). The temperature of the film blowing process is in a range from 180 to 240° C.

Hot pressing: the hot pressing temperature is 190° C., the hot pressing pressure is 1.5 Mpa and the hot pressing time is 6 min.

Cold pressing: the cold pressing temperature is 20° C., the cold pressing pressure is 1.5 Mpa and the cold pressing time is 5 min.

### Example 5

Polypropylene (PP) and polyvinyl chloride (PVC) scrap plastic alloy film is prepared, which is used as an adhesive material for the preparation of a 5-layer formaldehyde-free poplar plywood (thickness 5 mm). The steps are the same as those in Example 4.

Mixing the scrap plastics: the weight percentage of polypropylene is 80% and that of polyvinyl chloride is 20%. On the above basis, polyvinylidene fluoride which accounts for 3% by weight of the sum content of the plastics as the lubricant, titanate coupling agents which account for 8% by weight of the sum content of the plastics as the compatilizer and talcum powder which accounts for 10% by weight of the sum content of the plastics as the filler are respectively added.

Film is prepared by rolling apparatuses. The treatment temperature is in a range from 190 to 240° C.; the hot pressing temperature is 190° C.; the pressure of hot pressing and cold pressing is 2 Mpa; other parameters and conditions are the same as those in Example 4.

### Example 6

High density polyethylene (HDPE), polystyrene (PS), polypropylene (PP) and polyvinyl chloride (PVC) scrap plastic alloy film is prepared, which is used as the bonding material for the preparation of a 5-layer formaldehyde-free eucalyptus plywood (5-mm thick). The steps are the same as those in Example 4.

Mixing the scrap plastics: the weight percentages of high density polyethylene (HDPE), polystyrene (PS), polypropylene (PP) and polyvinyl chloride (PVC) are respectively 30%, 20%, 40% and 10%. On the above basis, ethylene bis stearamide which accounts for 5% by weight of the sum content of the plastics as the lubricant, maleic anhydride-modified polypropylene which accounts for 4% by weight of the sum content of the plastics as the compatilizer and light calcium carbonate which accounts for 20% by weight of the sum content of the plastics as the filler are respectively added.

Film is prepared by rolling apparatuses. The treatment temperature is in a range from 180 to 240° C.; the hot pressing temperature is 210° C.; other parameters and conditions are the same as those in Example 4.

In accordance with the water resistance, ordinary plywood can be classified into three types as Type I plywood, Type II plywood and Type III plywood. Type I plywood, i.e., weathering-resistant plywood, which can stand the boiling test, is used in outdoor conditions; Type II plywood, i.e., water-resistant plywood, which can stand the 63° C.-water immersion test, is often used in wet conditions; Type III plywood, i.e., weak damp-resistant plywood, is under dry conditions. In Examples 1 to 6 of the present invention, different plastic alloys or plastics are used for the preparation of plywood, whose performances and the costs thereof are significantly different based on different starting materials. The methods as provided in Plywood (GB/T 9846-2004) are adopted by the present invention to respectively test the water resistance of formaldehyde-free plywood prepared in Examples 1 to 6; and the different costs for preparing plywood based on different starting materials are also evaluated. The results are shown as follows.

| | | Water resistance | Adhesive cost |
|---|---|---|---|
| Examples | Alloy ratio | level | (RMB/ton) * |
| 1 | 100% HDPE | Type II plywood | 9,300 |
| 2 | 100% PP | Type I plywood | 11,000 |
| 3 | 100% LDPE | Type II plywood | 9,000 |
| 4 | 40% LDPE + 60% PP | Type I plywood | 10,000 |
| 5 | 80% PP + 20% PVC | Type I plywood | 9,000 |
| 6 | 30% HDPE + 20% PS + | Type I plywood | 9,500 |
| | 40% PP + 10% PVC | | |

* Note:
The adhesive cost refers to the approximate processing cost of scrap alloy film at present. The amounts of film used during the pressing processes in Examples 1 to 6 are basically the same.

It can be seen from the above table that, different alloys or plastics can be used to prepare plywood products of different water resistance levels. Meanwhile, the adhesive costs also vary greatly based on different starting materials. When plastic alloys are adopted, it is aimed to make the best of every single plastic so as to improve the comprehensive performances of the adhesive materials and thus to save costs.

Examples 1 and 3 respectively adopt HDPE and LDPE plastics. The bonding strength and water resistance therein cannot reach the requirements of Type I plywood. However, the heat resistance, cold resistance, chemical stability and toughness of the adhesive layers are good. The hardness, tensile strength and creep properties of HDPE are better than those of LDPE, and the toughness of HDPE is less than that of LDPE.

Example 2 adopts PP plastic, whose heat resistance, corrosion resistance, bonding performance are good enough for the preparation of Type I plywood. However, the adhesive layers are weak with poor impact resistance and are easily subject to aging. When used as structural plywood, assistant agents should be added to increase plasticity and toughness thereof, which increases the adhesive costs.

Example 4 adopts LDPE/PP alloy, synthesizing the toughness of LDPE and the rigidity and heat resistance of PP, such that not only the requirement of Type I plywood performances are met but also the toughness of the adhesive layers and the impact resistance of the plywood are improved.

Example 5 uses PP/PVC alloy to produce plywood, such that the bonding performances reach the requirements of Type I plywood; the replacement of part of PP with low-cost PVC greatly reduces the cost therein (2,000 RMB/ton lower than in Example 2); at the same time, PVC possesses good mechanical properties with certain degree of flame resistance, thus improving the comprehensive utility value of the plywood.

Example 6 adopts the HDPE/PP/PS/PVC alloy. The bonding performance therein reaches the requirements of Type I plywood; the cost is lower than that of Example 4; the heat resistance, cold resistance, chemical stability, toughness and bonding strength of the plywood are well balanced. The excellent thermal stability, mobility and easy forming process of PS at the melting state make the preparation and processing of the alloy film of various kinds of plastics more convenient.

The processing parameters can be changed to produce numerous selections and all the examples according to the present invention cannot be listed in detail. Some representative examples are listed above and the range of each parameter is provided in the technical solution thereof. All technical solutions using scrap plastics, especially the complementarities of various plastics to produce plywood fall within the protection scope of the present invention.

The above examples are some preferable examples of the present invention rather than any formal restrictions to the present invention. Although the preferable examples are disclosed as above, they are not intended to limit the present invention. Anyone skilled in the art without departing from the scope of the technical solution of the present invention can make small changes or modifications to the contents disclosed above to produce examples and their equivalents. Nevertheless, any contents without departing from the technical solutions of the present invention, and any simple changes, equivalent variations and modifications to the above examples according to the technical substance of the present invention fall within the protection scope of the technical solutions of the present invention.

1. A formaldehyde-free plywood, comprising at least two wood veneers, wherein the two wood veneers are bonded through scrap plastic alloy film free of formaldehyde, said scrap plastics comprising polypropylene and one or more selected from the group consisting of low density polyethylene, high density polyethylene, polyvinyl chloride, polystyrene and polycarbonates, the mass fraction of polypropylene in the scrap plastics being in a range from 40% to 80%.

2. The formaldehyde-free plywood according to claim 1, characterized in that the wood veneers are sheets formed by rotary cutting or slicing softwood or hardwood timber, wherein the thickness of the sheets falls within a range from 0.1 to 10 mm.

3. The formaldehyde-free plywood according to claim 1, characterized in that the timber for the wood veneers is selected from poplar, birch, eucalyptus, fir or pine.

4. The formaldehyde-free plywood according to claim 1, characterized in that the plastic scrap alloy film comprises:
(a) scrap plastics;
(b) based on (a), 0.001 to 15 wt % of a lubricant;
(c) based on (a), 0.001 to 12 wt % of a compatilizer; and
(d) based on (a), 0.001 to 25 wt % of a filler.

5. The formaldehyde-free plywood according to claim 4, characterized in that said scrap plastics comprise polypropylene and two, three or four selected from the group consisting of low density polyethylene, high density polyethylene, polyvinyl chloride, polystyrene and polycarbonates.

6. The formaldehyde-free plywood according to claim 4, characterized in that the lubricant is selected from the group consisting of ethylene bis stearamide, zinc stearate, aliphatic hydrocarbon waxes, oxidized polyethylene and polyvinylidene fluoride or any combinations thereof; the compatilizer is selected from the group consisting of stearic acid, titanate coupling agents, silane coupling agents or any combinations thereof; and the filler is selected from the group consisting of talcum powder, light calcium carbonate and diatomite or any combinations thereof.

7. A method for preparing the formaldehyde-free plywood according to claim 1, comprising the following steps:
Step (i): preparing the scrap plastic alloy film;
Step (ii): preparing a plywood mat; and
Step (iii): preparing the formaldehyde-free plywood,
wherein, Step (i) further comprises: classifying various types of scrap plastics and crushing the same respectively through plastic crushing machines and then cleaning them; blending the crushed particles with lubricant, compatilizer and filler according to a certain ratio; and mixing, prilling, film blowing or rolling the mixture to produce the scrap plastic alloy film, which preferably has a thickness in a range from 0.01 to 3 mm.

8. The method according to claim 7, characterized in that the temperatures in the processes of mixing, prilling, film blowing or rolling are all higher than the highest melting temperature of the scrap plastics, preferably in a range from 120 to 250° C.

9. The method according to claim 7, characterized in that Step (ii) further comprises: after drying at least two wood veneers, laying the scrap plastic alloy film therebetween, the grains in two adjacent veneers being vertically crossed with each other or the plywood as a whole being centrally symmetrical.

10. The method according to claim 7, characterized in that Step (iii) further comprises: firstly hot pressing and then cold pressing the plywood lay-up, wherein the hot pressing temperature is preferably 120 to 260° C., the hot pressing pressure is 0.8 to 10 Mpa, the hot pressing time based on the plywood thickness is 0.4 to 3 min/mm, the cold pressing temperature is lower than the lowest melting temperature of the raw materials of the plastic alloy, the cold pressing pressure is not lower than the hot pressing pressure, and the core temperature after the cold pressing is at least 30° C. lower than the lowest melting temperature of the raw materials of the plastic alloy.
